(19) United States
(12) Patent Application Publication
(10) Pub. No.: US 2025/0383949 A1
(43) Pub. Date: Dec. 18, 2025

(54) OPTIMIZED DATA GATHERING FOR DEFECT ANALYSIS

(71) Applicant: INTERNATIONAL BUSINESS MACHINES CORPORATION

(72) Inventors: Jonathan William Lewis Short, Eastleigh (GB); Roderick Guy Charles Moore, Bournemouth (GB); Tim McCarthy, Eastleigh (GB); Daniel S. Critchley, Winchester (GB)

(21) Appl. No.: 18/827,680

(22) Filed: Sep. 7, 2024

(30) Foreign Application Priority Data
Jun. 18, 2024 (GB) 2408735.5

(51) Int. Cl. G06F 11/07

(52) U.S. Cl. CPC G06F 11/0778; G06F 11/079

(57) ABSTRACT

A method, computer program product, and computer system for optimized data gathering for defect analysis. The method includes determining a defined defect category of a reported defect. The method then obtains current data set metadata for the defined defect category, where the data set metadata includes a defined content of the data set and a defined retrieval order of elements of the data set, and wherein the data set metadata is learned from monitoring data set retrieval from an end system during a debugging process. The method loads a data set from an end system for use by a debugging tool, with the data set having the defined content and loaded in the defined order according to the data set metadata.

### BACKGROUND

The present invention relates to data gathering for defect analysis, and more specifically, to optimized data gathering using ongoing learning for defect analysis.

Standard methods for debugging defects in computer systems use a set of debug tools capable of analyzing data gathered from a computer system. Traditional debugging methods involve gathering a static set of data from the computer system and debugging the data using the debug tools. Typically, some level of programming and or configuration intervention is required in order to modify the static set of data gathered for debug purposes.

For a given defect to be debugged in order to find the root cause, there may be an optimal data set needed for successful debug. Defining this data set can be done in several ways. In one method, all data is always gathered for all defects to be debugged. In another method, a fixed data set for a given category of defect is gathered, for example, an assert within a specific component of the system will offload only the data associated with that component.

### SUMMARY

According to aspects of the invention, a computer-implemented method, a system, and a computer program product are provided as defined in the claims.

According to an embodiment of the present invention there is provided a computer-implemented method for optimized data gathering for defect analysis, said method comprising: determining a defined defect category of a reported defect; obtaining current data set metadata for the defined defect category, wherein the data set metadata includes a defined content of the data set and a defined retrieval order of elements of the data set, and wherein the data set metadata is learned from monitoring data set retrieval from an end system during a debugging process; and providing a data set from an end system for use by a debugging tool, with the data set having the defined content and loaded in the defined order according to the data set metadata.

The described method has the advantage of, over time, providing an optimal data set and data set order in which to gather data required to debug a defect successfully and efficiently.

The method may include generating metadata using a learning process for each defined category including a defined content of the data set and a defined retrieval order of elements of the data set.

Determining a defined defect category for a reported defect may include: providing a core data set for defect category classification; and classifying the reported defect by comparing the reported defect to the core data set. Comparing the reported defect to the core data set may include comparing characteristics of the reported defect to the core data set.

The method may include: monitoring data set access during operation of a debugging tool for a defect category including access to the defined content of the current data set metadata for the defect category and access to additional content required by the debugging tool; maintaining a record of data set accesses; and applying a learning process to update the data set metadata for the defect category. The method may include applying a learning process to update the data set metadata to remove data set content that has not been accessed for a predefined number of defect category instances. The method may include: monitoring the data set access order of the defined content and the order of access to any other additional content; maintaining a record of data set access order; and applying a learning process to update data set metadata for the defect category.

An initial data set metadata for a defect category may defines all content of the data set and may be reduced over time to an optimal data set. A defined retrieval order of elements of the data set may include elements of discrete data stored in a data log or memory dump. The method may include generating additional operational metadata associated with a defect category including a history of data access requests and a history of the order in which data is requested for access.

According to another embodiment of the present invention there is provided a system for optimized data gathering for defect analysis, comprising: a processor and a memory configured to provide computer program instructions to the processor to execute the function of the components: a category determining component for determining a defined defect category of a reported defect; a metadata obtaining component for obtaining current data set metadata for the defined defect category, wherein the data set metadata includes a defined content of the data set and a defined retrieval order of elements of the data set, and wherein the data set metadata is learned from monitoring data set retrieval from an end system during a debugging process; and a data set providing component for providing a data set from an end system for use by a debugging tool, with the data set having the defined content and loaded in the defined order according to the data set metadata.

According to an embodiment of the present invention there is provided a computer program product for optimized data gathering for defect analysis, the computer program product comprising a computer readable storage medium having program instructions embodied therewith, the program instructions executable by a processor to cause the processor to: determine a defined defect category of a reported defect; obtain current data set metadata for the defined defect category, wherein the data set metadata includes a defined content of the data set and a defined retrieval order of elements of the data set, and wherein the data set metadata is learned from monitoring data set retrieval from an end system during a debugging process; and provide a data set from an end system for use by a debugging tool, with the data set having the defined content and loaded in the defined order according to the data set metadata.

The computer readable storage medium may be a non-transitory computer readable storage medium and the computer readable program code may be executable by a processing circuit.

### BRIEF DESCRIPTION OF THE DRAWINGS

Embodiments of the present invention will now be described, by way of example only, with reference to the accompanying drawings:

FIG. 1 is a block diagram of an example embodiment of a system in accordance with embodiments of the present invention;

FIG. 2A is a flow diagram of an example embodiment of an aspect of a method in accordance with embodiments of the present invention;

FIG. 2B is a flow diagram of an example embodiment of another aspect of a method in accordance with embodiments of the present invention;

FIGS. 3A and 3B are schematic diagrams illustrating a simplified example of data access requests over time used to learn the data set and data set order for a defect category according to aspects of the described method;

FIGS. 4A and 4B are schematic diagrams illustrating data access requests over time used to learn the data set and data set order for a defect category according to aspects of the described method;

FIG. 5 is a block diagram of an example embodiment of a system in accordance with embodiments of the present invention; and

FIG. 6 is a block diagram of an example embodiment of a computing environment for the execution of at least some of the computer code involved in performing the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for optimized data gathering for defect analysis using one or more debugging tools.

An optimal set of data that needs to be gathered and the order of access to the set of data is learned over time for a type of defect. This provides a method of continual monitoring of human behavior to enhance the system capability to provide an optimal data set and data set order needed to debug a particular type of defect. This enables a debugging system to collect that data to debug a defect successfully and efficiently.

Rather than always collecting a full set of data logs for each defect instance, a subset of data logs is collected thereby reducing the time taken to acquire the required set of data logs. Use of an optimal order of data log collection increases the chance of being able to attain root cause of a defect in a smaller amount of time. These criteria are constantly and dynamically modified to keep a permanently optimal debug capability.

The data gathering for defect analysis is an improvement in the technical field of computer defect analysis generally and more particularly in the technical field of efficient access of data for defect analysis.

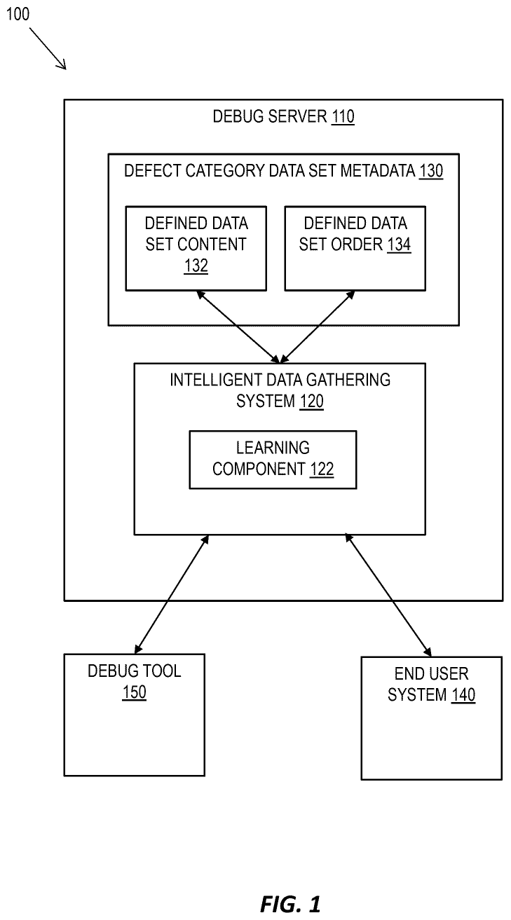

Referring to FIG. 1, a block diagram shows an example embodiment of a system 100 including an intelligent data gathering system 120.

The system 100 includes an end user system 140 that is a target system containing a memory dump and other formats of data to be gathered for debug purposes. The system 100 also includes a debug tool 150 in the form of a system of tools which enables access to all types of data formats (for example, binary data, log files, text files, etc.) needed to debug a defect.

A debug server 110 may be a centralized server capable of interacting with the debug tool 150 and the end user system 140 simultaneously. The debug server 110 runs the intelligent data gathering system 120 and maintains data set metadata 130 for each defect category including a defined data set content 132 for a defect category and a defined data set retrieval order for the defect category. The intelligent data gathering system 120 includes a learning component 122 which can interact with the debug tool 150 and is capable of gathering debug data from the end user system 140 to update the defect category metadata 130. The intelligent data gathering system 130 is capable of monitoring data requests from an instance of the debug tool 150 for a given defect category and by means of a learning process will adjust the given data set for that defect category.

A “defect category” is a type of defect for which a given data set is required to debug a defect of the type denoted by the defect category. A “core data set” is the minimum amount of data required to determine the defect category type for a defect.

A “data set” is a given set of data needed to debug a given defect category type defect. A “whole data set” is the total of all data available to the system. An “optimal data set” is a time derived minimized data set to enable debug. A “data set order” is the most common order in which data discrete elements in the data set is accessed by an engineer when debugging a defect. “Discrete data elements” may be a log file, a binary memory dump, or an error log, for example.

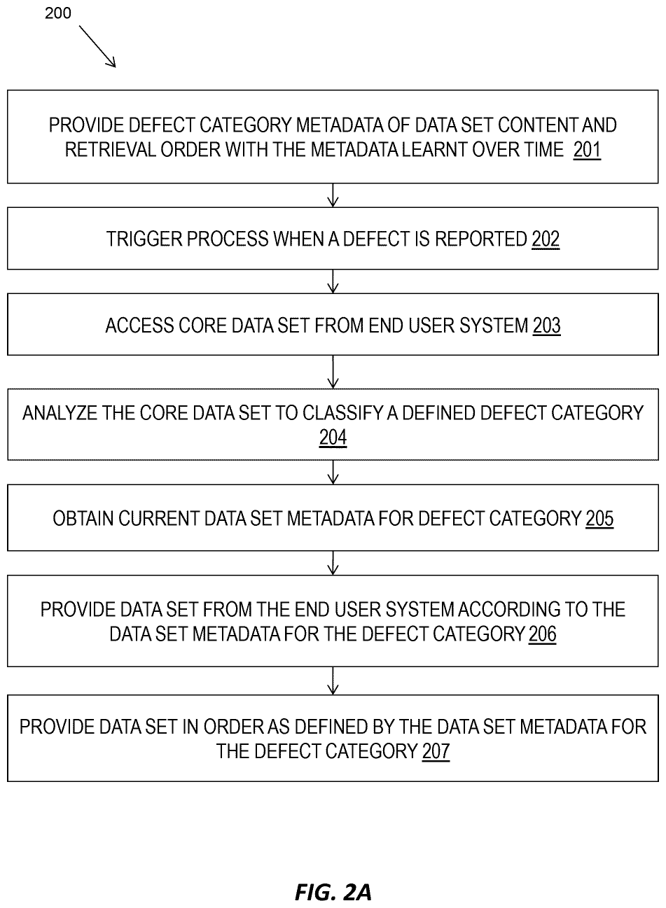

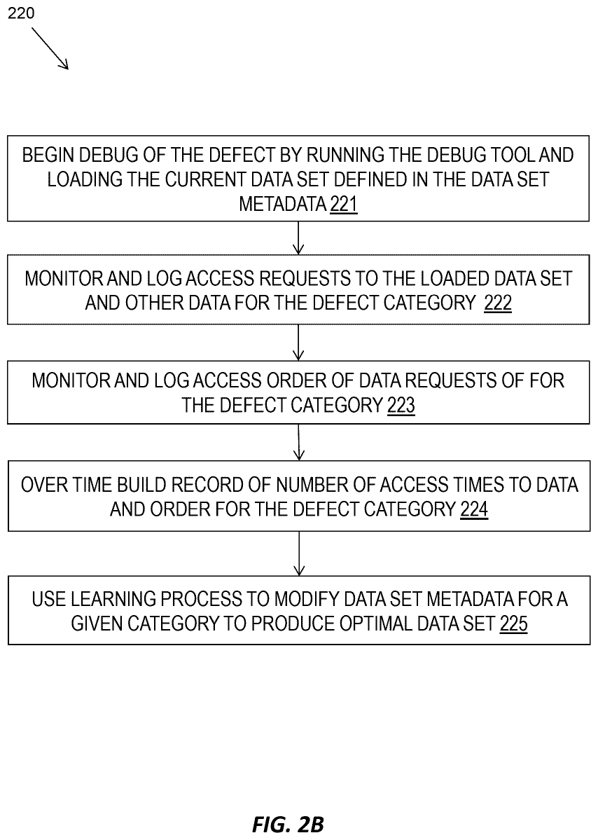

Referring to FIG. 2A, a flow diagram 200 shows an example embodiment of an aspect of the described method of data gathering for defect analysis. The method is carried out at the intelligent data gathering system 120.

The method provides 201 a defect category data set metadata 130 including defined data set content 132 and defined data set order 134. The data set metadata is learned by a learning process from monitoring data set retrieval from an end system during a debugging process. Initially, the defined data set content 132 may be a whole data set in the form of all data available to the system and over time this may be adapted to an optimal data set by the learning process. The learning process may use statistical learning or machine learning wherein the learning evolves over time.

The learning process of the metadata uses algorithms in the system that constantly examine the data set content selected for a given defect category, during each debug phase. A “heat map” may be generated of the most used data set elements (pieces of data from the data set, used for debug). The resulting “most used” data set from this analysis is periodically checked against the current recorded data set for the defect category and the data set is adjusted to match the most commonly selected data elements from the data set.

Similarly, algorithms in the system constantly examine the order in which data set elements are selected for a given debug category, during each debug phase. A “heat map” may be generated of the most common order of choice. The resulting most common order is periodically checked against the data set order for the debug category, and the data set order is adjusted to match the most commonly chosen order.

The data gathering process may be triggered 202 when a defect is reported. The method may access 203 a core data set from the end user system 140. A core data set is the minimum amount of data required to classify a defect as a defect category type. The method may analyze 204 the core data set to classify the reported defect in a defined defect category. The classification may compare aspects of the reported defect to the core data set.

The method may obtain 205 a current data set metadata for the defined defect category of the reported defect. The current data set metadata defines a most recent description of a defined content of the data set and a defined retrieval order of the data set for the defect category. The definitions of the data sets may be stored within the intelligent data gathering system with each data set defining which elements of data (for example, files, logs, etc.) are needed to debug the data set. The intelligent data gathering system uses the data set definition for a debug category to determine what data elements must be collected from the end user system and in what order for the debug to progress.

The defined data set content may be provided 206 from an end system for use by the debugging tool. The data set content may be provided 207 in data elements or groups of data elements in the defined order according to the data set metadata. This may pre-load the data set from the end user system to a datastore for use by the debugging tool.

The order of the data element retrieval enables the person performing the debug activity to be able to get the right information at the right time in the right order to be able debug the defect effectively. For example, if a debug engineer requires knowledge of an error code and a memory address for where to get the data needed to debug the next steps, it would not make sense to gather the binary memory dump first and then gather the error code logs and memory map data. It makes more sense to gather them in the reverse order. In summary it is about getting information to the debug engineer in the most logical order.

Referring to FIG. 2B, a flow diagram 220 shows an example embodiment of another aspect of the described method of data gathering for defect analysis. The method is carried out at the intelligent data gathering system 120.

The method may begin a debugging 221 of a defect by running the debug tool and loading the current data set content as defined in the data set metadata.

The method may monitor and log 222 requests to the data during operation of the debugging tool for a defect category including access to the defined content of the current data set for the defect category and access to additional content required by the debugging tool.

The method may monitor and log 223 the data set access order of the defined content and any other additional content for the defect category. The data set content and access may be provided in accordance with the current metadata; however, the debug process may request additional data content or may request the data in a different order such that the metadata is improved over time.

The monitoring and logging 222, 223 may monitor the usage or access frequency of a data set for the defect category. The method may build 224 over time a record of data set accesses and order for the defect category. This may build a record of the number of times a particular element of data is requested by the debug tool for a given defect category and the order in which discreet elements of data in the data set are requested. This includes requests for access to data not currently part of the data set.

The method may use a learning process 225 to modify the data set metadata for a given defect category based on the built record to produce an optimal data set. The modification may modify the data set content and the data set order.

The modification of the data set content may be based on a “most used” algorithm such that with time the data set for a given defect category will become the optimal data set needed to debug a defect of the category.

The modification of the data set order for a given defect category may be based on a “most used” algorithm i.e., the most frequently user order of data access requests and over time primary, secondary and tertiary sets of data are formed based on the ordering of groups of data requested by the user.

Continual analysis of debug data access patterns is used to adjust the metadata data set content and order. The metadata for the data set content and order is not fixed on a per code release basis, but rather dynamically updated in real time and is agnostic of the code level. The benefit of this model is that all code levels past and present can benefit from the debug learning done by the system over time. This includes being able to retrospectively apply this to previous code releases. The learning is done across the whole field population of end systems despite the code level being run on the end system.

In order to distinguish between types of defects, a defect is classified in a defect category for which a given set of data is required to debug that defect. To classify defect instances one or more characteristics are needed to create a set of discrete categories. Such characteristics may comprise and/or be a combination of: a unique software assert string; an event/error log; a string pattern from a trace file; a sequence of entries in a stack trace (being a history of recent processing activity); a definable set of binary data from memory trace; and other characteristics to suit desired debug goals. By means of using one or more of the elements listed above it is possible to define a unique defect category. The elements of the data used to classify a defect category are what denotes the required content of the core data set.

Each defect category is associated with a given data set. When the debug system is first commissioned, i.e., prior to any learning activity performed by the debug system, every defect category may have a data set associated with it which is equivalent to the whole data set. Over time and learning from retrieval of the data for debugging processes, the data set for a category will be honed and will approach an optimal state. Each defect category has a defect category metadata including defined data set content and defined data set order. Additional operational metadata associated with a defect category may include a history of data access requests i.e., which data is requested, and a history of the order in which data is requested for access.

An example system workflow is described below.

A defect is reported and the intelligent data gathering system (IDGS) is triggered by the defect report to retrieve the core data set from the end user system. The IDGS analyses the core data set to determine the defect category.

Using this information on defect category, the IDGS determines the data set needed to debug the issue according to the most recent data set description given in the data set metadata for the defect category.

The IDGS retrieves the data set for the defect category from the end user system. The order in which the data is retrieved from the end user system is denoted by the data set order as recorded against the defect category in the metadata. The purpose of this is to enable an engineer to begin their debug task as early as possible on the data set in the most used order of data analysis for a given defect category.

An engineer begins the task of debugging a defect by running the debug tool and loading up the data set.

Each time the engineer accesses a part of the data set the debug tool interacts with the IDGS and the IDGS logs that access request in the data records for the defect category. This is true if the access request is for data that is already part of the data set or if the data is not currently part of the data set. The IDGS also logs the order in which data access requests are made.

If the engineer requests access to data which is not currently part of the data set for the defect category, the IDGS retrieves that data from the end user system for the engineer to use in their analysis of the defect.

Over time, the IDGS builds a record of the number of times a particular bit of data is requested by the debug tool for a given defect category and the order in which discreet bits of data in the data set are requested.

The IDGS uses learning to modify the data set for a given defect category based on a “most used” algorithm such that with time the data set for a given defect category will become the optimal data set needed to debug a defect of the type denoted by that defect category. Note that data can be added to the data set or removed from the data set based on use or non-use of the data. Data that is not used for a threshold of n instances is demoted from the optimal data set.

The IDGS uses learning to modify the data set order for a given defect category based on a “most used” algorithm i.e., the most frequently user order of data access requests. Over time primary, secondary, and tertiary sets of data are formed based on the ordering of groups of data requested by the user.

Thus over time, an optimal data set and data set order in which to gather the data are defined algorithmically by the system to debug a defect successfully and efficiently.

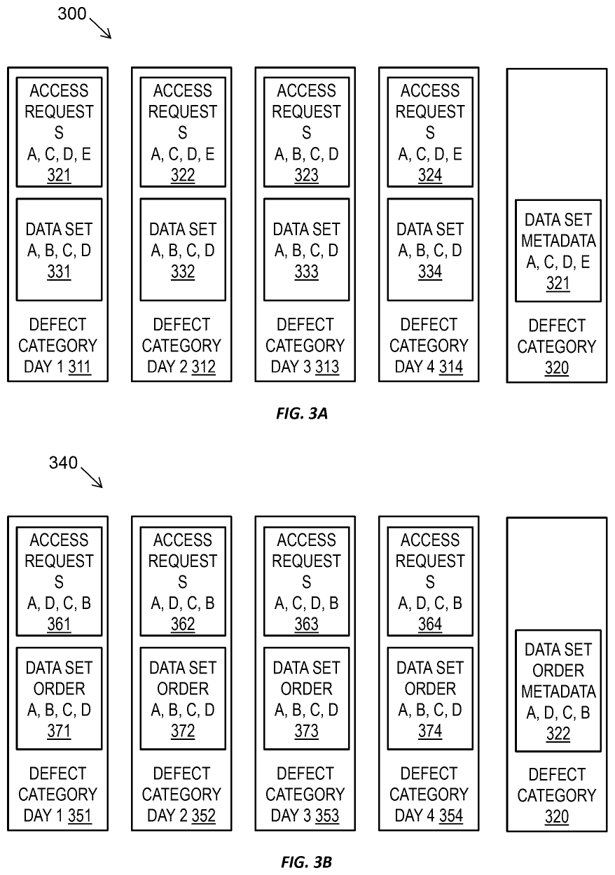

Referring to FIGS. 3A and 3B, schematic block diagrams 300, 340 illustrate the data set content 321 and order 322 optimization for gathering data for a defect category 320.

FIG. 3A shows a series of days 311-314 in which a defect category is debugged. Each letter represents an element of data in the data set. Initially the data set is comprised of data A, B, C, D 331-334. Access requests 321-324 are made on each day 311-314 of debugging. On day 1 311, the access requests 321 are for data elements A, C, D, E. On day 2 312, the access requests 322 are for data elements A, C, D, E. On day 3 313, the access requests 323 are for data elements A, B, C, D. On day 4 314, the access requests 324 are for data elements A, C, D, E. Over time, a pattern emerges as to the most frequently requested data elements. The data set metadata 321 for the defect category 320 is adjusted from the initial data set of A, B, C, D to the newly learned and optimized data set of A, C, D, E.

FIG. 3B shows a series of days 351-354 in which a defect category is debugged. Each letter represents an element of data in the data set. Initially the data set order is comprised of data A, B, C, D 371-374. Access requests 361-364 are made on each day 351-354 of debugging. On day 1 351, the access request order 361 is for data elements A, D, C, B. On day 2 352, the access request order 362 is for data elements A, D, C, B. On day 3 353, the access request order 363 is for data elements A, C, D, B. On day 4 354, the access request order 364 for data elements A, B, C, D. Over time, a pattern emerges as to the most frequently requested order. The data set order metadata 322 for the defect category 320 is adjusted from the initial data set of A, B, C, D to the newly learned and optimized data set order of A, D, C, B.

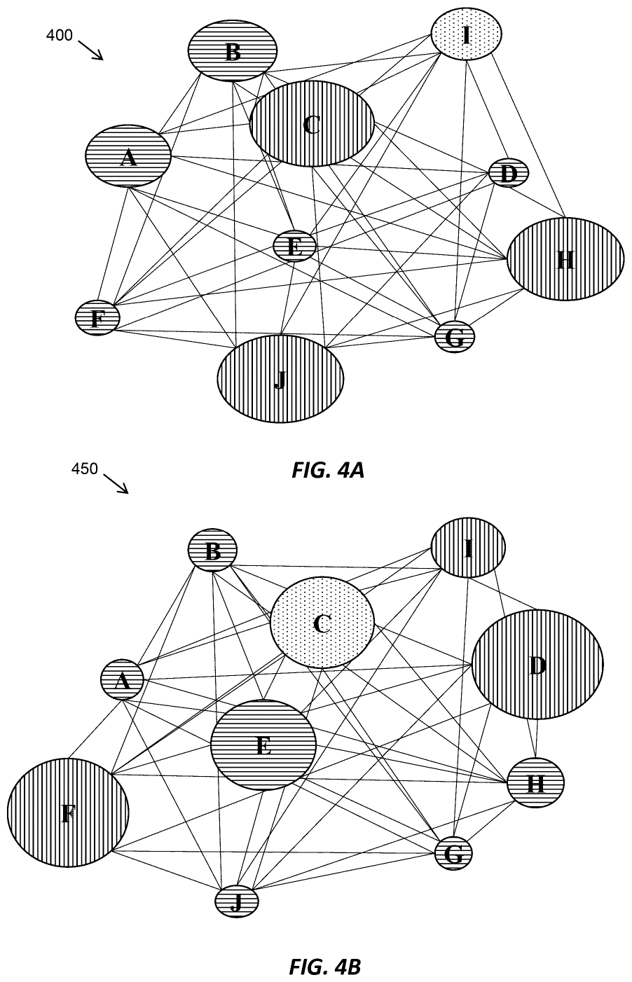

FIGS. 4A and 4B show schematic diagrams 400, 450 of network. map diagrams to represent how the intelligent data gathering system may internally model the data set content and the data set order for a first defect category shown in FIG. 4A and a second defect category shown in FIG. 4B. The size of each node represents how often a data set element (A to J) is used to debug the defect category. The patterning of each node represents the most common order in which a data set element is selected. For example, the nodes with the vertical lines show primary data, the nodes with the horizontal lines show secondary data, and the nodes with the dotted pattern shows tertiary data. In FIG. 4A, nodes C, H, and J are depicted with vertical lines to show primary data, nodes A, B, D, E, F, G are depicted with horizontal lines to show secondary data, and node I is depicted with a dotted pattern to show tertiary data. In FIG. 4B, nodes D, F, and I are depicted with vertical lines to show primary data, nodes A, B, E, J, G, and H are depicted with horizontal lines to show secondary data, and node C is depicted with a dotted pattern to show tertiary data.

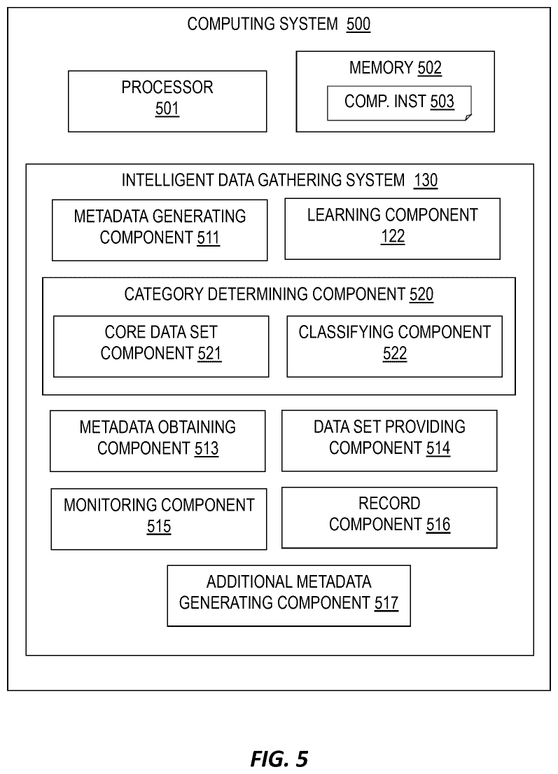

Referring to FIG. 5, a block diagram shows a computing system 500 on which an intelligent data gathering system 130 may be provided. The computing system 500 includes at least one processor 501, a hardware module, or a circuit for executing the functions of the described components which may be software units executing on the at least one processor. Multiple processors running parallel processing threads may be provided enabling parallel processing of some or all of the functions of the components. Memory 502 may be configured to provide computer instructions 503 to the at least one processor 501 to carry out the functionality of the components of the intelligent data gathering system 130.

The intelligent data gathering system 130 may include a metadata generating component 511 for generating metadata for each defined category including a defined content of the data set and a defined retrieval order of elements of the data set and updating the metadata using a learning component 122.

The intelligent data gathering system 130 may include a category determining component 520 for determining a defined defect category of a reported defect. The category determining component 520 may include a core data set component 521 for providing a core data set for defect category classification and a classifying component 522 for classifying the reported defect by comparing the reported defect to the core data set. The classifying component 522 may compare characteristics of the reported defect to the core data set.

The intelligent data gathering system 130 may include a metadata obtaining component 513 for obtaining current data set metadata for a defined defect category of a reported defect, where the data set metadata includes defined content of the data set and a defined retrieval order of elements of the data set.

The intelligent data gathering system 130 may include a data set providing component 514 for loading a data set from an end system for a reported defect for use by a debugging tool, with the data set having the defined content and loaded in the defined order according to the data set metadata.

The intelligent data gathering system 130 may include a monitoring component 515 for monitoring data set access during operation of a debugging tool for a defect category including access to the defined content of the current data set metadata for the defect category and access to additional content required by the debugging tool. The monitoring component 515 may also be for monitoring the data set access order of the defined content and the order of access to any other additional content.

The intelligent data gathering system 130 may include a record component 516 for maintaining a record of data set accesses and the data set access order. The learning component 122 may be for applying a learning process such as statistical learning or machine learning to update the data set metadata for the defect category based on the record component 516.

The intelligent data gathering system 130 may include an additional metadata generating component 517 for generating additional operational metadata associated with a defect category including a history of data access requests and a history of the order in which data is requested for access.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

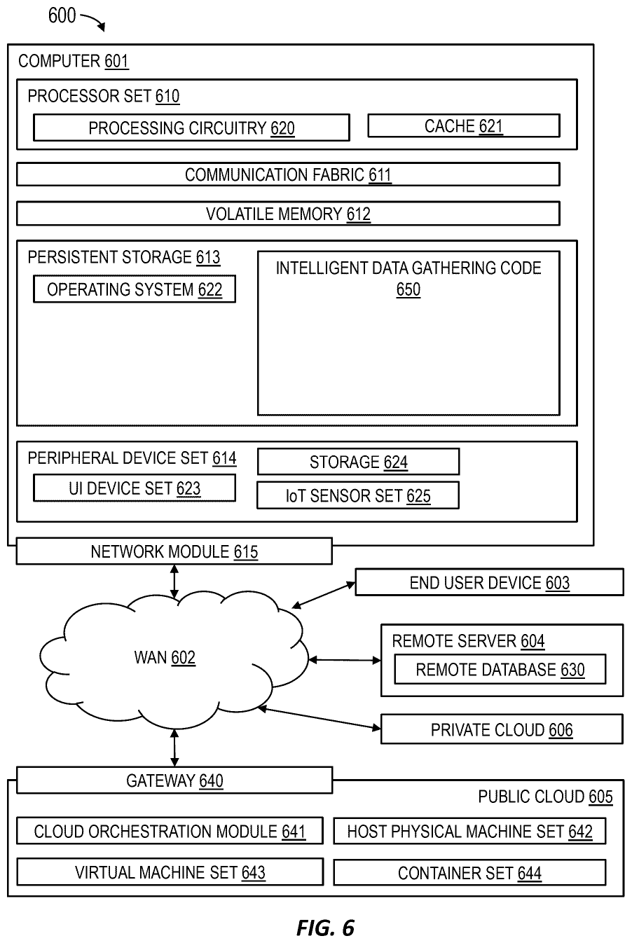

Referring to FIG. 6, computing environment 600 contains an example of an environment for the execution of at least some of the computer code involved in performing the inventive methods, such as intelligent data gathering code 650. In addition to block 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 650 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 650 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method for optimized data gathering for defect analysis, the method comprising:
determining a defined defect category of a reported defect;
obtaining current data set metadata for the defined defect category, wherein the data set metadata includes a defined content of the data set and a defined retrieval order of elements of the data set, and wherein the data set metadata is learned from monitoring data set retrieval from an end system during a debugging process; and
providing a data set from an end system for use by a debugging tool, with the data set having the defined content and loaded in the defined order according to the data set metadata.

2. The method of claim 1, further comprising:
generating metadata using a learning process for each defined category including a defined content of the data set and a defined retrieval order of elements of the data set.

3. The method of claim 1, wherein determining a defined defect category for a reported defect further comprises:
providing a core data set for defect category classification; and
classifying the reported defect by comparing the reported defect to the core data set.

4. The method of claim 3, wherein comparing the reported defect to the core data set includes comparing characteristics of the reported defect to the core data set.

5. The method of claim 1, further comprising:
monitoring data set access during operation of a debugging tool for a defect category including access to the defined content of the current data set metadata for the defect category and access to additional content required by the debugging tool;
maintaining a record of data set accesses; and
applying a learning process to update the data set metadata for the defect category.

6. The method of claim 5, wherein applying the learning process to update the data set metadata further comprises:
removing data set content that has not been accessed for a predefined number of defect category instances.

7. The method of claim 1, further comprising:
monitoring a data set access order of the defined content and the order of access to any other additional content;
maintaining a record of data set access order; and
applying a learning process to update data set metadata for the defect category.

8. The method of claim 1, wherein an initial data set metadata for a defect category defines all content of the data set and is reduced over time to an optimal data set.

9. The method of claim 1, wherein a defined retrieval order of elements of the data set includes elements of discrete data stored in a data log or memory dump.

10. The method of claim 1, further comprising:
generating additional operational metadata associated with a defect category including a history of data access requests and a history of the order in which data is requested for access.

11. A computer system for optimized data gathering for defect analysis, comprising:
a processor and a memory configured to provide computer program instructions to the processor to execute the function of the components:
a category determining component for determining a defined defect category of a reported defect;
a metadata obtaining component for obtaining current data set metadata for the defined defect category, wherein the data set metadata includes a defined content of the data set and a defined retrieval order of elements of the data set, and wherein the data set metadata is learned from monitoring data set retrieval from an end system during a debugging process; and
a data set providing component for providing a data set from an end system for use by a debugging tool, with the data set having the defined content and loaded in the defined order according to the data set metadata.

12. The computer system of claim 11, including a metadata generating component for generating metadata and updating using a learning process for each defined category including a defined content of the data set and a defined retrieval order of elements of the data set.

13. The computer system of claim 11, wherein the category determining component includes:
a core data set component for providing a core data set for defect category classification; and
a classifying component for classifying the reported defect by comparing the reported defect to the core data set.

14. The computer system of claim 13, wherein the classifying component compares characteristics of the reported defect to the core data set.

15. The computer system of claim 11, further comprising:
a monitoring component for monitoring data set access during operation of a debugging tool for a defect category including access to the defined content of the current data set metadata for the defect category and access to additional content required by the debugging tool;
a record component for maintaining a record of data set accesses; and
a learning component for applying a learning process to update the data set metadata for the defect category.

16. The computer system of claim 15, wherein the learning component includes applying a learning process to update the data set metadata to remove data set content that has not been accessed for a predefined number of defect category instances.

17. The computer system of claim 15, wherein the monitoring component is for monitoring a data set access order of the defined content and the order of access to any other additional content, the record component is for maintaining a record of data set access order, and the learning component is for applying a learning process to update data set metadata for the defect category.

18. The computer system of claim 11, wherein a defined retrieval order of elements of the data set includes elements of discrete data stored in a data log or memory dump.

19. The computer system of claim 11, further comprising:
an additional metadata generating component for generating additional operational metadata associated with a defect category including a history of data access requests and a history of the order in which data is requested for access.

20. A computer program product for optimized data gathering for defect analysis, comprising:
one or more computer readable storage media, and program instructions collectively stored on the one or more computer readable storage media, the program instructions comprising:
determining a defined defect category of a reported defect;
obtaining current data set metadata for the defined defect category, wherein the data set metadata includes a defined content of the data set and a defined retrieval order of elements of the data set, and wherein the data set metadata is learned from monitoring data set retrieval from an end system during a debugging process; and
providing a data set from an end system for use by a debugging tool, with the data set having the defined content and loaded in the defined order according to the data set metadata.
